(19) United States
(12) Patent Application Publication
(10) Pub. No.: US 2011/0230340 A1
(43) Pub. Date: Sep. 22, 2011

(54) DOPED ZIRCONIA CERAMIC

(76) Inventors: Jon Binner, Loughborough (GB); Balasubramaniam Vaidhyanathan, Loughborough (GB); Ketharam Annapoorani, Loughborough (GB); Anish Paul, Loughborough (GB)

(21) Appl. No.: 13/129,606

(22) PCT Filed: Nov. 27, 2009
(86) PCT No.: PCT/GB2009/002771

§ 371 Date: May 17, 2011

(30) Foreign Application Priority Data
Nov. 27, 2008 (GB) 0821674.9

(51) Int. Cl. C04B 35/48; B01J 32/00

(52) U.S. Cl. 502/439; 501/103

(57) ABSTRACT

The present invention provides the use of a doped zirconia ceramic having a mean grain size of about 190 nm or less and consisting of the tetragonal zirconia crystallographic phase as a hydrothermally stable material or in an application that requires the use of a hydrothermally stable material. The present invention also provides a doped zirconia ceramic having a mean grain size of about 190 nm or less and consisting of tetragonal zirconia which does not undergo detectable tetragonal to monoclinic transformation during aging in moisture in an autoclave at a temperature of up to about 245° C. for up to 504 hours at a pressure of up to 7 bar.

The present invention relates to doped zirconia (ZrO₂) ceramics that have a nanostructure and that can be fully dense, or can have a deliberately controlled porosity.

Conventional zirconia ceramics are doped with additives, such as yttria, in order to control a crystallographic phase transition. At room temperature pure zirconia exists in a monoclinic form. At elevated temperatures, typically above 1100° C., it transforms to a tetragonal form. This transformation is accompanied by a 4 to 5% volume change that can cause the material to fall apart. The presence of doping stabilizes the high temperature form, preventing the destructive transformation from occurring on cooling. Partial stabilization of the high temperature form can yield some excellent mechanical properties. Different types and levels of additive have been used to produce zirconia ceramics suitable for different applications.

For example, yttria-doped zirconias are generically referred to as yttria stabilized zirconia or YSZ. Often, a number is placed in front to indicate the Y₂O₃ content. For example, 3YSZ indicates that the yttria-doped zirconia comprises 3 mol % yttria.

Conventional zirconia-based ceramics are not very stable in moist environments at around room or body temperature and just above; the degradation process is most intensive at temperatures of 150-300° C. In the presence of water, the desirable tetragonal crystallographic phase converts to the undesirable monoclinic phase, eliminating the beneficial mechanical properties as it does so.

It is known that conventional 3YSZ ceramics start to exhibit the first indications of conversion after as little as half an hour at 140° C. (the industry standard testing temperature) in the presence of steam. Over just a few hours, this drastically reduces the mechanical performance. This prevents these conventional ceramics from being used in applications such as surgical equipment (due to the need to repeatedly sterilize equipment, which typically involves heating to >100° C. in a steam environment), or various industrial applications (for example the ceramic might otherwise be used as a valve or pump component in the oil, petrochemical and power generation industry), or for catalyst support applications in water-bearing environments. It also prevents the ceramics from being used in lower temperature applications, such as artificial replacement joints in people or animals, because these devices need to be sterilised before being implanted and although it can take much longer (years) for the degradation to occur, such replacements need to have a lifespan of 10 to 20 years or more.

Nanostructured materials have received much attention in recent years. This is largely due to their potential to display unexpected and unusual physical and mechanical properties as a result of the very high fraction of atoms that reside in the grain boundaries.

Note: The listing or discussion of an apparently prior-published document in this specification should not necessarily be taken as an acknowledgement that the document is part of the state of the art or is common general knowledge.

The present invention provides doped zirconia ceramics having a mean grain size of about 190 nm or less and consisting of the tetragonal crystallographic phase and the use of such ceramics as hydrothermally stable materials.

By “consisting of the tetragonal crystallographic phase” we mean that the ceramics do not comprise any detectable amounts of the monoclinic or cubic crystallographic phases.

The doped zirconia ceramics used in the present invention are capable of resisting, for extended periods of time (weeks), a change in their crystalline phase, even when in the presence of moisture at elevated temperatures (at least up to 245° C.) and pressures (at least up to 7 bar) and hence retain their mechanical properties even when subjected to these conditions.

As used herein, we define a hydrothermally stable material as a material, which when subjected to a temperature of 245° C. and a pressure of up to 7 bar for 504 hours does not undergo any detectable transformation in its crystalline phase (as measured using currently available techniques such as X-ray diffraction or micro Raman spectroscopy).

The ceramics used in the present invention are nanostructured zirconia-based ceramics that have enhanced stability in moist environments, as defined above, compared to conventional zirconia-based materials. These ceramics are used in applications is which hydrothermal stability is advantageous and/or essential.

The ceramics used in the present invention comprise a doped zirconia. Suitable dopants include, but are not limited to, yttria, magnesia and ceria and mixtures thereof. In the following description, the invention will be illustrated by reference to yttria doped zirconia-based ceramics. However, it will be appreciated that the scope of the invention is not limited to these materials.

The doped zirconia ceramics used in the present invention have a mean grain size of about 190 nm or less. The mean grain size of the ceramics can be determined by any suitable method known in the art. For example, the mean grain size can be determined by direct measurement via electron microscopy or via indirect methods such as X-ray diffraction line broadening, though the latter technique can be less precise.

The yttria stabilised ceramics of the invention may be stabilised by 2.5 mol % or more of yttria. The upper limit for yttria addition is not particularly limited. Usually the upper limit for the yttria content is about 8 mol %, alternatively it may be about 6 mol % or 4 mol %. For example, the ceramics of the invention may comprise from about 2.5 mol % to about 8 mol % yttria, or from about 3 mol % to about 8 mol % yttria. Ceramics comprising about 3 mol % of yttria, for example from about 2.5 mol % to about 4 mol % yttria are preferred for some applications.

The ceramics of the invention have a mean grain size of less than about 190 nm more preferably less than about 180 nm. The lower limit for mean grain size is not particularly limited. The lower limit for the mean grain size is typically about 10 nm; alternatively it may be about 20 nm or 30 nm. Preferably the ceramics of the invention have a mean grain size of from about 150 nm to about 50 nm or about 100 nm or less. Examples of ranges for the mean grain size include from about 100 nm to about 150 nm or about 180 nm or about 190 nm or from about 50 nm or about 60 nm to about 80 nm.

It should be noted that there is always a spread of grain sizes. For this reason, the grain size is quoted in this document as the ‘mean grain size’. As an example, when the mean grain size is 65 nm, the spread of grain sizes may be as shown in FIG. 1.

The ceramics used in the invention may consist essentially of zirconia and the dopant. For example they may consist essentially of doped zirconia stabilised by a dopant as listed above, e.g. yttria. Other impurities or additives may also be present in limited quantities, typically 0.5 wt % or less. The ceramics used in the invention may consist of zirconia and the dopant, for example they may consist of zirconia stabilized by a dopant as listed above, for example yttria in amount as described above.

The ceramics used in the invention consist entirely of the tetragonal crystalline phase. By this we mean that within the limits of current detection methods the ceramics used are purely in the tetragonal crystalline phase. Methods by which the crystal structure of ceramics can be determined include X-ray diffraction and micro Raman spectroscopy; both have current detection limits of about ±2%. Hence the ceramics used in the invention consist of at least 98% of the tetragonal crystalline phase and up to 100% of this phase.

The ceramics used in the present invention can have strengths up to approximately 1 GPa. The strength of the ceramics is not significantly altered when the ceramics are subjected to the hydrothermal conditions mentioned above.

The ceramics used in the invention are very much more stable in moist environments than conventional doped zirconia ceramics, such as conventional yttria stabilized zirconias.

Moist environments can be defined as environments in which the ceramic is in contact with water or steam. Such environments include those having a relative humidity of about 20% or more, for example about 40% or more, or 50% or more or 60% or more and up to 100% (saturated humidity) and a temperature above 0° C. and up to at least 245° C.

The ceramics used in the invention can be considered to be more hydrothermally stable than conventional micron-grained materials. For example, the 3YSZ ceramics of the invention, having a mean grain size of about 80 nm, can survive at least three weeks (about 504 hours) at least 245° C. in the presence of steam with zero indication of the phase change (that is the tetragonal to monoclinic phase change) occurring (within current limits of detection using techniques such as X ray diffraction or micro Raman spectroscopy). This means that the mechanical properties of the ceramics of the invention do not change when they have been subjected to these conditions. It is known that conventional 3YSZ ceramics start to exhibit the first indications of conversion after as little as half an hour at 140° C. (the industry standard testing temperature) in the presence of steam. This one property alone could revolutionise many industries, ranging from the petrochemical industry (valve and pump components) through catalyst supports to biomedical applications (surgical equipment to implants or artificial body parts).

The nanostructured doped zirconia ceramics used in the invention are suitable for use in various applications in which it is essential that the material used does not degrade in a moist environment. For example, the ceramics of the invention may be used in pump and valve components, particularly those which are used in moist environments at high temperature and/or pressure, catalyst supports, surgical tools and biomedical applications such as femoral heads femoral heads and other artificial body parts. There are of course, many other possible uses.

The table below summarise some of the most important properties of materials suitable for various applications.

| Application | Required Property |
|---|---|
| Pump and valve components; | Hydrothermal stability (i.e. no transformation |
| this could involve the use of | at up to 250° C. for periods of weeks or |
| dense ceramic liners or | months in a water-bearing environment) + |
| coatings on other materials | erosion resistance + high strength |
| Catalyst supports; this could | High strength + high surface area/porosity + |
| involve the use of shaped | hydrothermal stability (i.e. no transformation |
| components made from | at up to 250° C. for periods of weeks or |
| highly porous ceramics | months in a water-bearing environment) |
| Femoral heads or other | Hydrothermal stability (i.e. ability to withstand |
| implants; this could involve | sterilisation and no transformation at 37° C. |
| the use of dense ceramic | for up to 20 years within a human or animal |
| components of a range | body) + high strength and wet wear resistance |
| of sizes | |
| Surgical tools; this could | Hardness + ability to withstand repeated |
| involve the use of dense | sterilisation (i.e. hydrothermal stability after |
| ceramic components | repeated exposure to moisture at temperatures |
| | up to at least those typically used for the |
| | sterilisation of surgical tools) |

In one aspect, the ceramic used consists essentially of zirconia doped with yttria, for example in an amount as described above, has a mean grain size below about 190 nm and consists of the tetragonal crystallographic phase and does not undergo detectable tetragonal to monoclinic transformation or show significant hardness or strength deterioration after aging in moist environments (i.e. in environments having a relative humidity of about 20% or more) in an autoclave or other environment at a temperature of up to at least about 245° C. for up to at least about 504 hours at pressures up to 7 bar. By the phrase “does not undergo detectable tetragonal to monoclinc transformation” we include the meaning no transformation is detected when using X-ray diffraction or micro Raman spectroscopy for phase analysis.

Normally both X-ray diffraction and micro Raman spectroscopy have has detection limits of ±2%. When we say that there is not a significant hardness or strength deterioration, we mean that they deteriorate by no more than about 10%, or no more than 5% or no more than 1%.

Some preferred ceramics for use in the invention do not undergo any phase transformation after wear testing for at least 100,000 cycles at 20 N load under water using a linearly reciprocating ball-on-flat sliding wear test (ASTM G 133-05). Materials having this property are particularly suitable for applications in which the material is required to be wear resistant. For example, they are particularly suitable for use in valves, pumps, femoral heads and other such applications.

The density of the ceramics used in the invention can vary within wide limits. For example, the materials may be fully dense, i.e. have a density greater than or equal to about 99% of the theoretical density. On the other hand, the ceramics may have a deliberately low density, for example, less than 50% of the theoretical density. These lower density materials are particularly suitable for applications such as catalyst supports. Thus, the invention provides the use of ceramics of the invention as catalyst supports and catalyst supports comprising a ceramic as described herein.

The ceramics of the invention can be made by any suitable method. For example, they can be made by a method as described in J Binner et al, ‘Processing of bulk nanostructured ceramics’, J. Eur. Ceram. Soc. 28 1329-1339 (2008).

The ceramics used in the invention can be used in any suitable form. For example, they may be used to provide the entire component or article, for example as a bioimplant, or they may form a hydrothermally stable coating or layer on or in an article, for example as a layer in or on the surface of a pump or valve component, or a specific component within an article, for example an insert within a part designed for a wear application, may consist essentially of the ceramic. The ceramic may be fully dense, for example in surgical tools, bioimplants or pump or valve components, or may be deliberately porous, for example in catalyst supports.

For example, the ceramic can be used to give an article which would not otherwise be hydrothermally stable, resistance to degradation under hydrothermal conditions. In this aspect, the article can be coated with the ceramic. In the context of the present invention, when we refer to hydrothermal conditions we mean a temperature of up to at least 245° C. and a pressure of up to at least 7 bar for up to at least 504 hours.

When the ceramic is used as a coating any suitable coating method known in the art may be used. Suitable coating methods include, but are not limited to, deposition or printing or casting from a suspension or other medium.

It will be appreciated that the thickness of a coating or a layer within an article will depend on factors such as the size of the article and the intended purpose of the article. It will be within the skill of the person of ordinary skill in the art to determine an appropriate thickness for a coating or layer. For example, they might be a few micrometres thick for some applications through to a few millimetres thick for others.

In the claims which follow and in the preceding description of the invention, except where the context requires otherwise due to express language or necessary implication, the word “comprise” or variations such a “comprises” or “comprising” is used in an inclusive sense, i.e. to specify the presence of the stated features but not to preclude the presence or addition of further features in various embodiments of the invention. Likewise, the wording “consisting essentially of” or variations such as “consists essentially of” is used to indicate the presence of the stated features and to indicate that other features/ingredients may be present provided that they do not have a material effect of the properties of the embodiment of the invention e.g. on the properties of the ceramic. The word “consisting” or “consists” is used in an exclusive sense, i.e. to specify the presence of the stated features and to preclude the presence or addition of further features in various embodiments of the invention.

### BRIEF DESCRIPTION OF THE FIGURES

FIG. 1 illustrates a typical grain size distribution of a 3YSZ ceramic of the invention having a mean grain size of 65 nm.

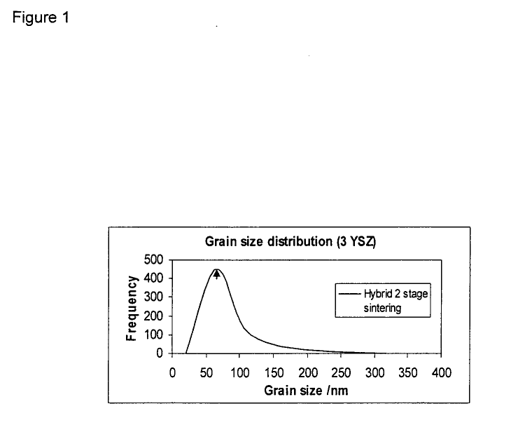

The invention is illustrated by the following non-limiting examples.

### EXAMPLE 1

### Hydrothermal Ageing Studies

Yttria stabilised zirconia nanosuspension with a solid content of ˜20-25% by weight solids was obtained from MEL Chemicals, Swinton, UK. The average particle size was approximately 18 nm, as measured by Transmission Electron Microscopy. The as-received suspension had an acidic pH around 2.4 which was modified using tetra methyl ammonium hydroxide (TMAH) to pH ˜11. To this suspension, 3 wt % tri ammonium citrate (TAC) was added as the dispersant and concentrated to ˜60% by weight solids by evaporating water at 60° C. under continuous stirring whilst exposing the suspension to ultrasound at regular intervals to assist in breaking up any agglomerates present.

The green bodies used in the present work were prepared by slip casting the concentrated suspension of the nanozirconia described above, though other process routes may also be used as described in J Binner et al, ‘Processing of bulk nanostructured ceramics’, J. Eur. Ceram. Soc. 28 1329-1339 (2008). Plaster of Paris (POP) moulds were used for the casting; the grade being Lafarge, Prestia millecast. The mould containing the cast samples was left under laboratory conditions for up to 72 h to allow initial drying of the body. After this stage the samples were removed from the mould cavity and placed on a Teflon sheet for 48 h whilst the body continued to dry further. The use of a Teflon sheet was to achieve minimal resistance to shrinkage for the samples, thus keeping drying stresses to a minimum. After fully drying, the samples were heated to 700° C. at 0.5° C. per minute to remove the organics present (TAC & TMAH). Typical green body densities were 50-52% of theoretical density.

The samples were then sintered using a two-step sintering cycle where the samples were first heated to a high temperature (1150° C.), held at that temperature for a very short period of time (6 seconds), cooled down to a lower temperature (1050° C.) and held at that temperature for 10 h so that complete densification was achieved. This sintering schedule resulted in ceramics that were >99% of theoretical density whilst retaining a final mean grain size of 95 nm.

A benchmark submicron sample was prepared by dry pressing of the powder followed by single step sintering as recommended by the powder supplier. The benchmark powder used was Tosoh 3YSB-C which was made in the form of small discs by die pressing at a pressure of 150 MPa. The discs were then directly fired at 1500° C. for 2 hours to obtain greater than or equal to 99% of the theoretical density and a final mean grain size of 0.52 μm.

Hydrothermal ageing studies were conducted to evaluate the hydrothermal degradation resistance of the various zirconia ceramics. Ageing experiments were performed for a number of different samples, viz. the commercial submicron 3YSZ and nanostructured zirconia with different yttria contents. The ageing experiments were conducted in an oven using an autoclave, with a PTFE liner, containing deionised water. The temperature and pressure were varied for different samples. The initial ageing studies were performed at 140° C. temperature and 4 bar pressure. These conditions were selected as they are close enough to the conditions used for the hydrothermal ageing studies of biomedical grade zirconia ceramics (according to J. Chevalier, J. M. Drouin and B. Cales, Bioceramics, Volume 10, Edited by L. Sedel and C. Rey (Proceedings of the 10th International Symposium on Ceramics in Medicine, Paris, France, October 1997) 1 h of ageing at 134° C. and 2 bar pressure is equivalent to 4 years of in-vivo ageing at 37° C. and atmospheric pressure). The ageing temperature was increased up to 245° C. for selected samples and 7 bar pressure. The samples were aged for up to 21 days under these conditions. Phase transformation was monitored using X-ray diffraction and micro-Raman spectroscopy, see table 1, and the possible deterioration in mechanical properties with ageing was studied using both a microhardness tester and strength measurements. No significant reduction was observed in the mechanical properties for the nano 3YSZ after 504 hours at either 140° C. or 245° C. Note: 336 h accelerated ageing at 140° C. and 4 bar pressure is equivalent to more than 1300 years in vivo ageing.

TABLE 1
Degree of phase transformation after hydrothermal ageing

| | Monoclinic content detected/vol % | | | | |
|---|---|---|---|---|---|
| | Commercial | | | Commercial | |
| | subμm | Nano | Nano | subμm | Nano |
| Ageing | 3YSZ at | 2YSZ at | 3YSZ at | 3YSZ at | 3YSZ at |
| time/h | 140° C. | 140° C. | 140° C. | 245° C. | 245° C. |
| 0 | 0 | 0 | 0 | 0 | 0 |
| 0.5 | 3.4 | — | 0 | — | 0 |
| 1 | 4.2 | — | 0 | Sample | 0 |
| | | | | disintegrated | |
| 2 | 10.7 | — | 0 | Sample | 0 |
| | | | | disintegrated | |
| 4 | 17.7 | — | 0 | Sample | 0 |
| | | | | disintegrated | |
| 8 | 34.1 | — | 0 | Sample | 0 |
| | | | | disintegrated | |
| 16 | 55.5 | — | 0 | Sample | 0 |
| | | | | disintegrated | |
| 24 | 65.9 | 12.7 | 0 | Sample | 0 |
| | | | | disintegrated | |
| 48 | 69.7 | — | 0 | Sample | 0 |
| | | | | disintegrated | |
| 120 | 70.2 | 22.2 | 0 | Sample | 0 |
| | | | | disintegrated | |
| 168 | 73.5 | — | 0 | Sample | 0 |
| | | | | disintegrated | |
| 336 | Sample | — | 0 | Sample | 0 |
| | disintegrated | | | disintegrated | |
| 504 | Sample | — | 0 | Sample | 0 |
| | disintegrated | | | disintegrated | |

### EXAMPLE 2

### Determination of Wear Properties

Wear testing of nano and commercial submicron samples were carried out as per ASTM G 133-05 using linearly reciprocating ball-on-flat sliding wear.

The wear testing set up has the capability to carry out the test under a variety of lubricants, but only wear under water at room temperature is reported for the present samples. All the zirconia-based ceramics to be tested were mounted in epoxy resin and polished to the same fine surface finish (average surface roughness parameter Ra<50 nm). A 12 mm diameter tungsten carbide-cobalt ball (5-7% cobalt) was used as the ball specimen. A constant 20 N load was applied on the test specimen through the ball specimen, even though it was possible to use different loads. The total number of cycles was 100,000 with 2.5 cm stroke length, which is equivalent to a total sliding distance of 5 km. After thorough drying, the weight loss of the sample and the ball on wear testing was measured and the wear volume was calculated. After wear testing, the samples were cleaned by ultrasound in distilled water, acetone and in methanol. The wear scar on the zirconia-based ceramic specimens were analysed using FEGSEM, XRD and micro-Raman spectroscopy. It was observed that for the commercial submicron samples the wear damage largely originated from the phase transformation that had occurred causing material to spall off the sample surface, whilst for the nano 3YSZ sample there was no evidence of any phase transformation and so the mechanism was fundamentally different.

TABLE 2
Sample wear loss after linearly reciprocating
ball-on-flat sliding wear testing under water

| Sample | No of | Applied | Wear volume/ |
|---|---|---|---|
| name | cycles | load/N | mm³ |
| Commercial | 100,000 | 20 | 1.05 |
| subμm 3YSZ | | | |
| Nano 3YSZ | 100,000 | 20 | 0.64 |

1. A doped zirconia ceramic having a mean grain size of about 190 nm or less and consisting of a tetragonal zirconia crystallographic phase, the ceramic being useful as a hydrothermally stable material or in an application that requires the use of a hydrothermally stable material.

2. The ceramic according to claim 1, wherein the zirconia is doped with yttria.

3. The ceramic according to claim 2, wherein the ceramic comprises from about 2.5 mol % to about 8 mol % yttria.

4. The ceramic according to claim 3, wherein the ceramic comprises from about 2.5 mol % to about 4 mol % yttria.

5. The ceramic according to claim 4, wherein the ceramic comprises about 3 mol % yttria.

6. The ceramic according to claim 1 wherein the ceramic has a mean grain size of from 150 nm to 50 nm.

7. The ceramic according to claim 1 wherein the ceramic has a mean grain size of less than 100 nm.

8. A pump component or valve component comprising a ceramic according to claim 1.

9. A surgical tool or femoral head or other artificial body part comprising a ceramic according to claim 1.

10. A catalyst support comprising a ceramic according to claim 1.

11. A pump component or valve component, comprising a doped zirconia ceramic having a mean grain size of about 190 nm or less and consisting of the tetragonal zirconia crystallographic phase.

12. A surgical tool, femoral head or other artificial body part comprising a doped zirconia ceramic having a mean grain size of about 190 nm or less and consisting of the tetragonal zirconia crystallographic phase.

13. A catalyst support comprising a doped zirconia ceramic having a mean grain size of about 190 nm or less and consisting of the tetragonal crystallographic phase.

14. A doped zirconia ceramic having a mean grain size of about 190 nm or less and consisting of tetragonal zirconia which does not undergo detectable tetragonal to monoclinic transformation during aging in moisture in an autoclave at a temperature of up to about 245° C. for up to 504 hours at a pressure of up to 7 bar.

15. A ceramic according to claim 14, wherein the zirconia is doped with yttria.

16. A ceramic according to claim 15, comprising from about 2.5 mol % to about 8 mol % yttria.

17. A ceramic according to claim 16, comprising from about 2.5 mol % to about 4 mol % yttria.

18. A ceramic according to claim 17, comprising about 3 mol % yttria.

19. A ceramic according to claim 14 having a mean grain size of from 150 nm to 50 nm.

20. A ceramic according to claim 14 having a mean grain size of less than 100 nm.

21. A ceramic according to of claim 14 which does not undergo phase transformation after wear testing for at least 1,000,000 cycles at 20 N load under water using a linearly reciprocating ball-on-flat sliding wear test (ASTM G133-05).

22. A hydrothermally stable article comprising a ceramic as defined in claim 14.

23. A pump component or valve component, comprising a ceramic according to claim 14.

24. A surgical tool, femoral head or other artificial body component comprising a ceramic according to claim 14.

25. A catalyst support comprising a ceramic according to claim 14.

26. (canceled)

27. (canceled)
